(19) United States
(12) Patent Application Publication
(10) Pub. No.: US 2018/0167361 A1
(43) Pub. Date: Jun. 14, 2018

(54) Network Attack Prevention Method, Apparatus and System

(71) Applicant: Alibaba Group Holding Limited, Grand Cayman (KY)

(72) Inventors: Hongliang Xiao, Zhejiang (CN); Dacheng Zhang, Zhejiang (CN)

(21) Appl. No.: 15/893,302

(22) Filed: Feb. 9, 2018

Related U.S. Application Data
(63) Continuation of application No. PCT/CN2016/093186, filed on Aug. 4, 2016.

(30) Foreign Application Priority Data
Aug. 13, 2015 (CN) 201510497226.1

(51) Int. Cl. H04L 29/06; H04L 29/12

(52) U.S. Cl. CPC H04L 63/0236; H04L 61/1511; H04L 63/1458; H04L 63/1441; H04L 63/101

(57) ABSTRACT

A method, an apparatus and a system for preventing network attacks are provided. The method includes receiving a target DNS response message that is directed to an internal network device and sent from an external network device; determining whether the target DNS response message satisfies predetermined conditions under a circumstance that a dynamic white list includes a source address in the target DNS response message; and discarding the target DNS response message if the target DNS response message satisfies the predetermined conditions, wherein the predetermined conditions include at least a target domain in the target DNS response message being not included in a historical domain record, each historical domain name in the historical domain name record being extracted from historical DNS response messages sent by the external network device.

### CROSS REFERENCE TO RELATED PATENT APPLICATIONS

This application claims priority to and is a continuation of PCT Patent Application No. PCT/CN2016/093186 filed on 4 Aug. 2016, and is related to and claims priority to Chinese Patent Application No. 201510497226.1, filed on 13 Aug. 2015, entitled “Network Attack Prevention Method, Apparatus and System,” which are hereby incorporated by reference in their entirety.

### TECHNICAL FIELD

The present invention relates to the field of networking technologies, and particularly to network attack prevention methods, apparatuses and systems.

### BACKGROUND

Along with the continuous development of network technologies, the number of network attacks in the network field have increased. Currently, a distributed denial of service (DDoS) has become a relatively severe attack trick among a number of network attacks. DNS response attacks in DDoS have become a mainstream attack type. The DNS response attacks may also be called domain name system (DNS) response attacks.

In order to prevent DNS response attacks, an elimination device is added into an original system to form a prevention system. FIG. 1 is a schematic structural diagram of a prevention system. In the figure, a by-pass of an elimination device can be found to be deployed on one side of a router.

In a situation when a bypass of an elimination device is deployed, a source detection method can be used to eliminate invasive DNS response messages that are sent from external network devices to internal network devices. A specific process of eliminating may be to extract a source address and determine whether the source address is included in a dynamic white list after an elimination device receives a DNS response message sent from an external network device to an internal network device. If the source address is not included in the dynamic white list, a DNS request message is sent as a probe message to the external network device. If no DNS response message that is returned from the external network device is received, the external network device is determined to be a fake source, and the DNS response message is discarded. If a DNS response message returned from the external network device is received and a domain in the DNS response message satisfies a certain requirement, the external network device is determined to be a real source, and an IP address of the external network device is added into the dynamic white list. If the source address is included in the dynamic white list, the external network device is a real source, and the DNS response message is transmitted.

DNS response attacks can also be classified according to types of attack: a real source attack and a fake source attack. Since a dynamic white list only includes IP addresses of real sources, and does not include IP addresses of fake sources, the source detection method can only eliminate DNS response attacks initiated from the fake sources, and cannot eliminate DNS response attacks initiated from the real sources.

Accordingly, a method for eliminating DNS response attacks initiated from the real sources is needed now, to reduce the impact on services and networks caused by DNS response attacks.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or computer-readable instructions as permitted by the context above and throughout the present disclosure.

The present disclosure provides network attack prevention method, apparatus and system to eliminate DNS response attacks initiated from real sources to reduce the impact on services and networks caused by the DNS response attacks.

In order to achieve the above goals, the present disclosure provides the following technical measures.

A network attack prevention method includes receiving a target DNS response message that is directed to an internal network device and sent from an external network device; determining whether the target DNS response message satisfies predetermined conditions under a circumstance that a dynamic white list includes a source address in the target DNS response message; and discarding the target DNS response message if the target DNS response message satisfies the predetermined conditions, wherein the predetermined conditions include at least a target domain in the target DNS response message being not included in a historical domain record, each historical domain name in the historical domain name record being extracted from historical DNS response messages sent by the external network device.

In implementations, the predetermined condition further include a time difference between a first sending time and a second sending time initiated by the external network device for the target domain name is less than a predetermined time difference, wherein the first sending time is a time of sending the target DNS response message, and the second sending time is a time of sending a most recent DNS response message that includes the target domain name prior to the first sending time.

In implementations, the method further includes transmitting the target DNS response message to the internal network device under a circumstance that the time difference is not less than the predetermined time difference.

In implementations, the method further includes storing the domain name and a sending time of the target DNS response message into the historical domain name record if the target domain name in the target DNS response message is not included in the historical domain name record.

In implementations, the method further includes calculating a ratio between a number of domain names having a hit rate greater than a predetermined number and a total number of domain names, wherein the historical domain name record includes all domain names and respective hit rates of the domain names in historical DNS response messages sent by the external network device, and the predetermined number is not less than a natural number of three; and deleting a source address of the external network device from the dynamic white list and adding the source address of the external network device into a dynamic black list if the ratio is greater than a predetermined ratio.

In implementations, a method of calculating a hit rate of each domain name in the historical domain name record includes finding a domain name in a DNS response message in the historical domain name record after receiving the DNS response message; and increasing a hit rate of the domain name by one, wherein an initial value of the hit rate of each domain name is zero.

In implementations, the predetermined conditions further include a total throughput value of a throughput value of the target DNS response message and a throughput value of the historical DNS response messages being greater than a predetermined throughput value, wherein the historical DNS response messages are all DNS response messages sent by the external network device before the target DNS response message is sent.

In implementations, the method further includes deleting the source address from the dynamic white list and adding the source address into a dynamic black list in response to the total throughput value is greater than the predetermined throughput value.

In implementations, a process of calculating the throughput value of the historical DNS response messages includes adding a throughput value of a DNS response message to the throughput value of the historical DNS response messages after the DNS response message is sent from the source address of the external network device, an initial value of the throughput value of the historical DNS response messages is zero.

In implementations, the method further include discarding the target DNS response message when the dynamic black list includes the source address in the target DNS response message.

A network attack prevention apparatus includes a receiving unit used for receiving a target DNS response message that is directed to an internal network device and sent from an external network device; a determination unit used for determining whether the target DNS response message satisfies predetermined conditions under a circumstance that a dynamic white list includes a source address in the target DNS response message; and a first discarding unit used for discarding the target DNS response message if the target DNS response message satisfies the predetermined conditions, wherein the predetermined conditions include at least a target domain in the target DNS response message being not included in a historical domain record, each historical domain name in the historical domain name record being extracted from historical DNS response messages sent by the external network device.

In implementations, the predetermined condition further include a time difference between a first sending time and a second sending time initiated by the external network device for the target domain name is less than a predetermined time difference, wherein the first sending time is a time of sending the target DNS response message, and the second sending time is a time of sending a most recent DNS response message that includes the target domain name prior to the first sending time.

In implementations, the apparatus further includes a transmission unit used for transmitting the target DNS response message to the internal network device when the time difference is not less than the predetermined time difference.

In implementations, the apparatus further includes a storage unit used for storing the domain name and a sending time of the target DNS response message into the historical domain name record if the target domain name in the target DNS response message is not included in the historical domain name record.

In implementations, the apparatus further includes a ratio calculation unit used for calculating a ratio between a number of domain names having a hit rate greater than a predetermined number and a total number of domain names, wherein the historical domain name record includes all domain names and respective hit rates of the domain names in historical DNS response messages sent by the external network device, and the predetermined number is not less than a natural number of three; a first deletion unit used for deleting a source address of the external network device from the dynamic white list if the ratio is greater than a predetermined ratio; and an first addition unit used for adding the source address of the external network device into a dynamic black list.

In implementations, the apparatus further includes a hit rate calculation unit used for finding a domain name in a DNS response message in the historical domain name record after receiving the DNS response message, and increasing a hit rate of the domain name by one, wherein an initial value of the hit rate of each domain name is zero.

In implementations, the predetermined conditions further include a total throughput value of a throughput value of the target DNS response message and a throughput value of historical DNS response messages being greater than a predetermined throughput value, wherein the historical DNS response messages are all DNS response messages sent by the external network device before the target DNS response message is sent.

In implementations, the apparatus further includes a second deletion unit used for deleting the source address from the dynamic white list when the total throughput value is greater than the predetermined throughput value; and a second addition unit used for adding the source address into a dynamic black list.

In implementations, an apparatus further includes a throughput calculation unit used for adding a throughput value of a DNS response message to the throughput value of the historical DNS response messages after the DNS response message is sent from the source address of the external network device, an initial value of the throughput value of the historical DNS response messages is zero.

In implementations, the apparatus further include a second discarding unit used for discarding the target DNS response message when the dynamic black list includes the source address in the target DNS response message.

A network attack prevention system includes an external network device, an elimination device, and an internal network device.

The external network device is used for sending a target DNS response message directed to the internal network device to the elimination device.

The elimination device is used for receiving the target DNS response message that is directed to the internal network device from the external network device; determining whether the target DNS response message satisfies predetermined conditions under a circumstance that a dynamic white list includes a source address in the target DNS response message; and discarding the target DNS response message if the target DNS response message satisfies the predetermined conditions, wherein the predetermined conditions include at least a target domain in the target DNS response message being not included in a historical domain record, each historical domain name in the historical domain name record being extracted from historical DNS response messages sent by the external network device.

The internal network device is used for receiving DNS response messages from the elimination device after going through elimination.

As can be seen from the above technical content, the present disclosure has the following beneficial effects.

After determining that a source address in a target DNS response message is included in a dynamic white list, the embodiments of the present disclosure can determine that an external network device that initiates the target DNS response message is not a fake source, but a real source. One type of DNS response attacks initiated from a real source is to frequently send DNS response messages having different domain names to attack an internal network device. Therefore, the present disclosure sets up a historical domain name record, in which all domain names sent by the external network device are recorded.

When a target domain name in the target DNS response message is not included in the historical domain name record, this indicates that the external network device sends a DNS response message including this domain name for the first time. In this situation, the target DNS response message may be a DNS response attack initiated by the external network device using different domain names. In order to prevent the internal network device from an attack, the target DNS response message is discarded.

Since a normal external network device has an automatic resending mechanism, if a DNS response message sent by the normal external network device is discarded, the target DNS response message is resent after the external network device receives a DNS request message resent from an internal network device. Therefore, the present disclosure does not affect sending of normal DNS response messages to an internal network device. However, an invasive external network device does not have this resending mechanism. Therefore, the present disclosure can filter out DNS response messages that attack an internal device from a real source using different domain names, thus relieving the impact on services and networks caused by DNS response attacks.

### BRIEF DESCRIPTION OF THE DRAWINGS

In order to understand the embodiments of the present disclosure or technical schemes in existing technologies in a better manner, drawings that are needed for describing the embodiments or the existing technologies are briefly described herein. Apparently, the drawings described herein merely represent some embodiments of the present disclosure. One of ordinary skill in art can obtain other drawings without making any creative effort based on these drawings.

FIG. 1 is a schematic structural diagram of a prevention system.

FIG. 2 is a flowchart of a network attack prevention method in accordance with the embodiments of the present disclosure.

FIG. 3 is a flowchart of another network attack prevention method in accordance with the embodiments of the present disclosure.

FIG. 4 is a flowchart of changing a dynamic white list in a network attack prevention method in accordance with the embodiments of the present disclosure.

FIG. 5 is a flowchart of another network attack prevention method in accordance with the embodiments of the present disclosure.

FIG. 6 is a schematic structural diagram of a network attack prevention method in accordance with the embodiments of the present disclosure.

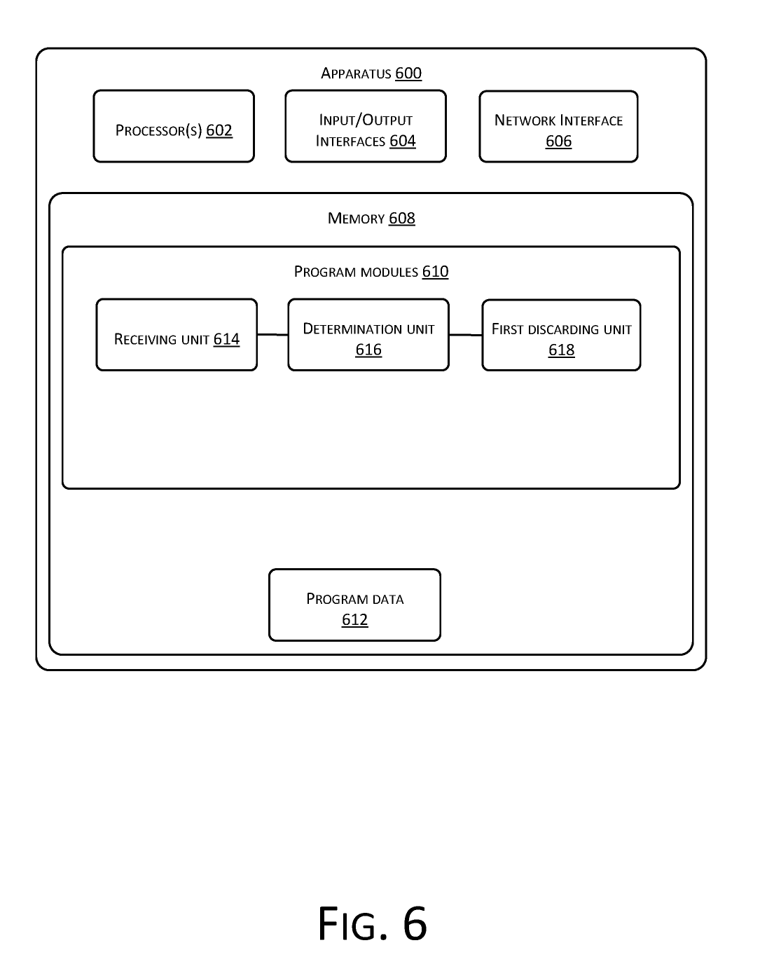

FIG. 7 is a schematic structural diagram of another network attack prevention method in accordance with the embodiments of the present disclosure.

FIG. 8 is a schematic structural diagram of another network attack prevention method in accordance with the embodiments of the present disclosure.

### DETAILED DESCRIPTION

Technical solutions of the embodiments of the present disclosure are described in a clear and comprehensive manner in conjunction with the drawings in the embodiments of the present disclosure. Apparently, the described embodiments merely represent some and not all of the embodiments of the present disclosure. Based on the embodiments in the present disclosure, all other embodiments that are obtained by one of ordinary skill in the art without making any creative effort shall fall in the scope of protection of the present disclosure.

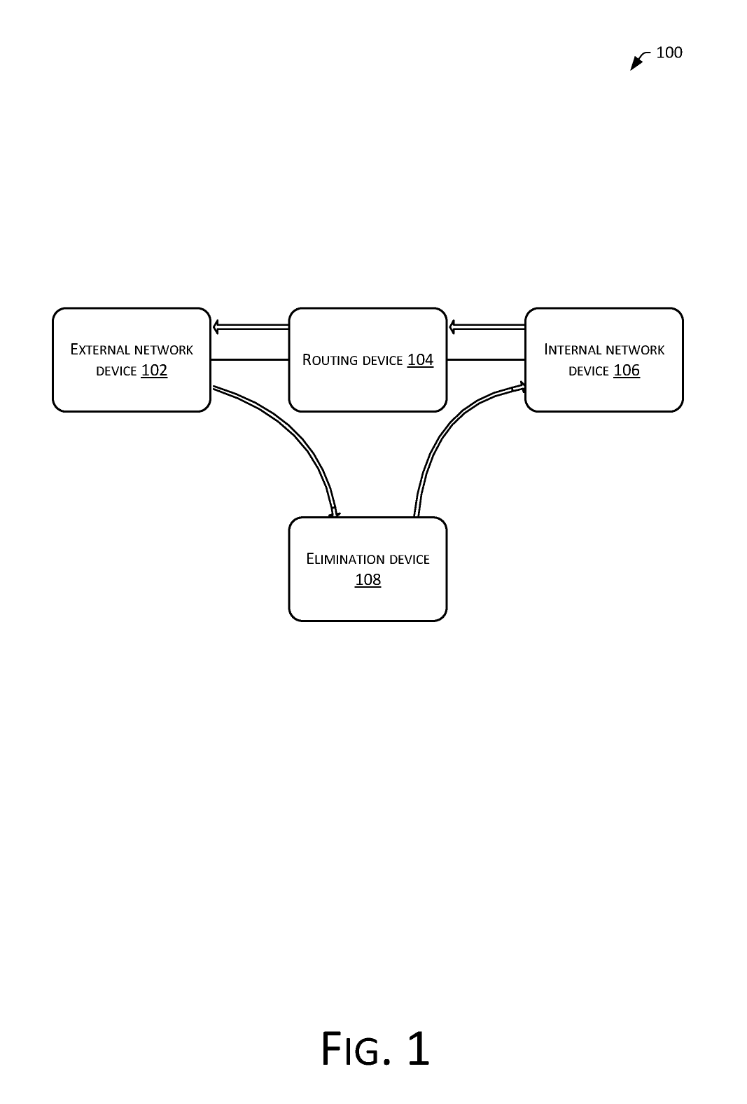

In order to describe an application scenario of the present disclosure in a better manner, FIG. 1, which is a prevention system 100 of network attacks, is referenced. The system 100 includes an external network device 102, a routing device 104, an internal network device 106, and an elimination device 108 that is deployed as a by-pass of the routing device 104.

The external network device 102 is used for sending DNS response messages directed to the internal network device 106 to the elimination device 108. The DNS response messages sent by the external network device may include invasive DNS response message(s) among normal DNS response messages. Therefore, the elimination device 108 is used for eliminating the invasive DNS response messages from the normal DNS response messages of the external network device, and transmitting the normal DNS response messages to the internal network device 106 after removing the invasive DNS response message(s).

Based on the prevention system of network attacks as shown in FIG. 1, the present disclosure provides a network attack prevention method. The present disclosure only uses an external network device and an internal network device to which the external network device intends to access for making a detailed description. It can be understood that implementations of other external network devices and internal network devices are consistent with the method provided in the present disclosure.

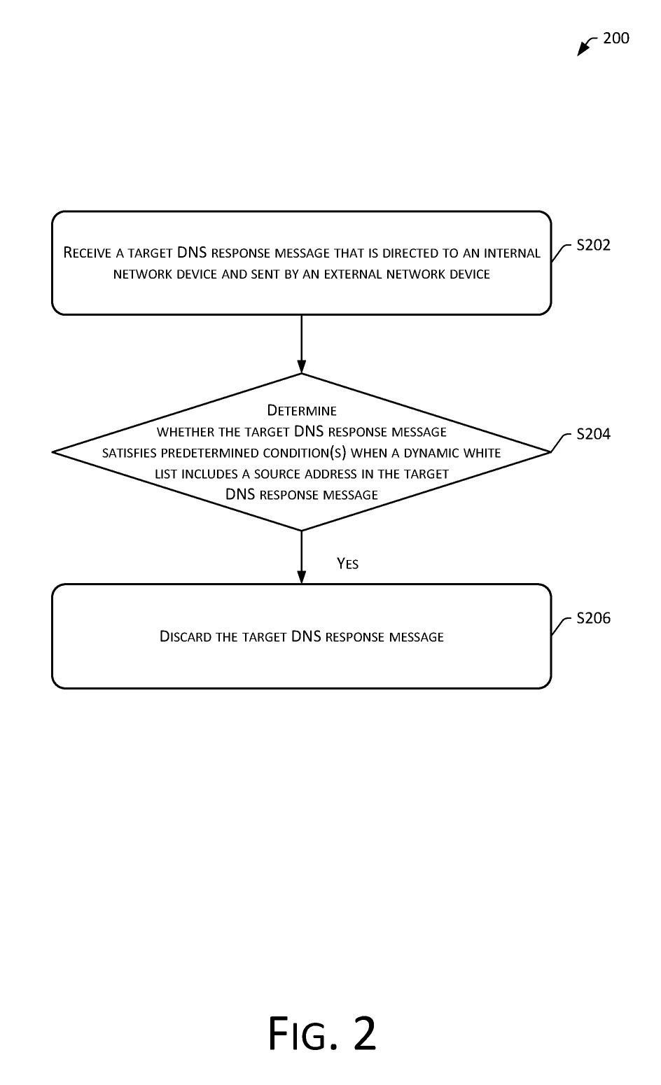

As shown in FIG. 2, the present disclosure provides a network attack prevention method 200, which is applied in an elimination device. The method includes the following operations S202-S206.

S202 receives a target DNS response message that is directed to an internal network device and sent by an external network device.

After receiving a command of sending a target DNS response message, an external network device sends the target DNS response message for an internal network device to an elimination device. The target DNS response message includes a source address (IP address) of the external network device that sends the target DNS response message, and a target domain name of the internal network device that needs to be accessed by the external network device. In response to receiving the target DNS response message, the elimination device can perform determination on the target DNS response message, to determine whether the target DNS response message is an invasive DNS response message.

S204 determines whether the target DNS response message satisfies predetermined condition(s) when a dynamic white list includes a source address in the target DNS response message.

A dynamic white list is set up in the elimination device. The dynamic white list stores IP addresses of real sources that are not invasive for the time being. IP addresses that are not invasive in the dynamic white list are temporary. When a certain IP address has changed into an invasive IP address according to a determination condition of the present disclosure, this IP address is deleted from the dynamic white list. In other words, IP addresses in the dynamic white list of the present disclosure are not fixed, and are dynamically changing. Therefore, it is called as a dynamic white list. After receiving the target DNS response message, the elimination device extracts a source address of the external network device from the target DNS response message, and determines with the dynamic white list includes the source address of the external network device.

If the dynamic white list does not include the source address of the external network device, a determination is made as to whether the external network device corresponding to the source address is a fake source using a source detection method. If the external network device is a fake source, the target DNS response message is an invasive DNS response message sent by the fake source, and therefore the target DNS response message is discarded.

If the dynamic white list includes the source address of the external network device, this indicates that the external network device is a real source. The target DNS response message is a DNS response message sent by a real source. Along with the development of attack technologies, a real source can also be used as a source of attack by an attacker. Therefore, a further determination needs to be made after determining that the external network device is a real source, to determine whether the target DNS response message is an invasive message.

Since a first way of initiating DNS response attacks from a real source is to frequently send DNS response messages having different domain names to attack an internal network device, the elimination device of the present disclosure creates a historical domain name record for each IP address in the dynamic white list. A historical domain name record is used for recording a domain name including a DNS response message sent from each IP address. As can be seen, the elimination device in the present embodiment also has a historical domain name record corresponding to the external network device, which records domain names that appear in historical DNS response messages sent by the external network device.

In order to further determine whether the target DNS response message is an invasive message, the present embodiment sets up predetermined condition(s) in advance. The predetermined condition(s) include(s) at least a target domain in the target DNS response message being not included in a historical domain record, each historical domain name in the historical domain name record being extracted from historical DNS response messages sent by the external network device.

After determining that the dynamic white list includes the source address of the target DNS response message, a target domain name in the target DNS response message is extracted. A determination is further made as to whether a historical domain name record corresponding to the source address includes the target domain name, i.e., determining whether the target DNS response message satisfies the predetermined conditions.

S206 discards the target DNS response message if the target DNS response message satisfies the predetermined condition(s), or performs other processing if the target DNS response message does not satisfy the predetermined condition(s).

If the historical domain name record does not include the target domain name, this indicates that the external network device sends the DNS response message having the target domain name for the first time. In this situation, the target DNS response message may be a DNS response attack initiated by the external network device using a manner of different domain names. Therefore, the target domain name does not exist in the historical domain name record. In this situation, in order to prevent the internal network device from an attack, the target DNS response message is discarded. This process can be called as “first packet discarding mechanism”.

It can be understood that the target DNS response message may be initiated by a normal external network device (the external network device accesses the internal network device corresponding to the target domain name for the first time). If the target DNS response message is assumed to be normal in the present disclosure, the target DNS response message is discarded in the present operation. Accordingly, after the target DNS response message is discarded, the target domain name is stored in the historical domain name record, so that a target domain name in a target DNS response message that resent by the normal external network device according to a resending mechanism is included in the historical domain name record. In other words, the target domain name in the historical domain name record is hit, thereby ensuring that normal DNS messages are not discarded due to “first packet discarding mechanism”.

Since normal external network devices have a resending mechanism, after the internal network device sends a DNS request to the external network device, the internal network device sends a DNS request message to an external network if no DNS response message is received from the external network device. Due to triggering of the DNS request message, the normal external network device will resend the target DNS response message. When the elimination device receives the target domain name again, the target DNS response message is not discarded again due to “first packet discarding mechanism because the historical domain name record has included the target domain name, thus ensuring that normal DNS response messages are not affected.

Invasive external network devices do not have resending mechanism. Therefore, the present disclosure can accurately eliminate DNS response messages that attack the internal network device by a real source using a manner of different domain names, thereby reducing the impact on services and networks caused by DNS response attacks.

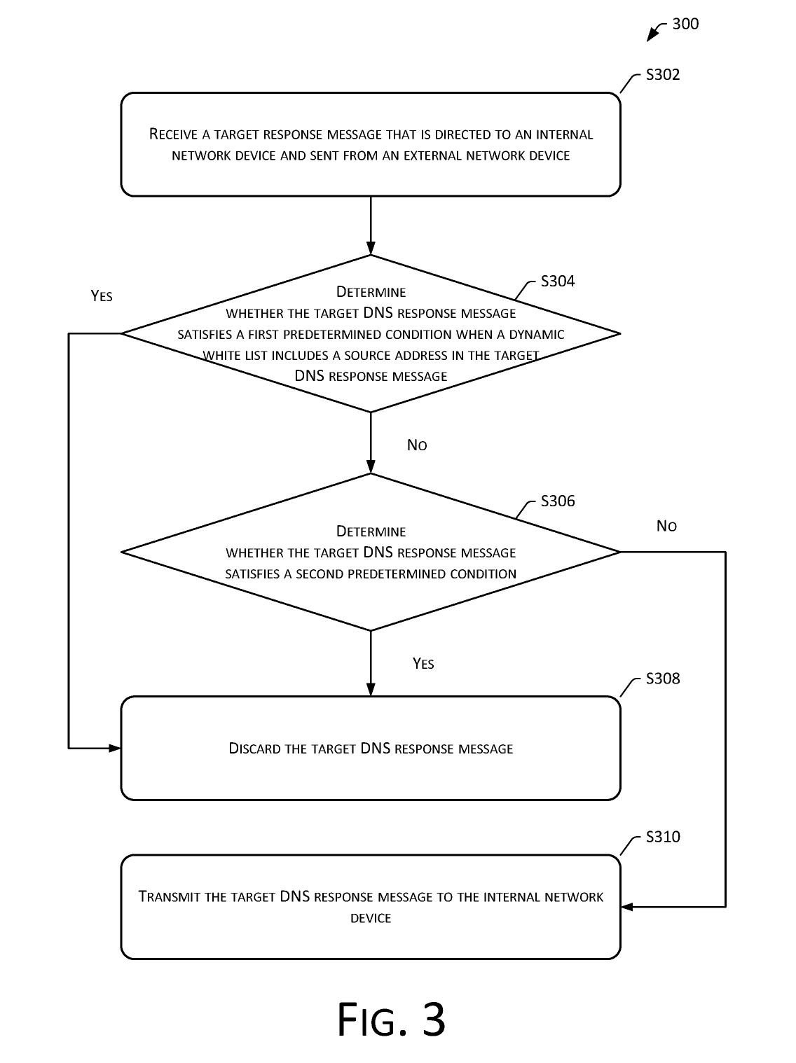

A second embodiment of a prevention method of network attacks that is provided by the present disclosure is described as follows. As shown in FIG. 3, the method 300 includes operations S302-S310.

S302 receives a target response message that is directed to an internal network device and sent from an external network device.

S304 determines whether the target DNS response message satisfies a first predetermined condition when a dynamic white list includes a source address in the target DNS response message. The first predetermined condition includes a target domain name in the target DNS response message not being included in a historical domain name record. The method proceeds to S306 if the first predetermined condition is not satisfied, or proceeds to S308 if the first predetermined condition is satisfied.

A specific process of performing the present operation has been described in detail in the embodiment shown in FIG. 2, and is not repeatedly described herein.

S306 determines whether the target DNS response message satisfies a second predetermined condition. The second predetermined condition includes a time difference between a first sending time and a second sending time initiated by the external network device for the target domain name being less than a predetermined time difference, wherein the first sending time is a time of sending the target DNS response message, and the second sending time is a time of sending a most recent DNS response message that includes the target domain name prior to the first sending time. If the second predetermined condition is satisfied, S308 is entered. If the second predetermined condition is not satisfied, S310 is entered.

A second way of initiating DNS response attacks from a real source is to frequently send DNS response messages using a limited number of domain names or a same domain name. Since a frequency of sending DNS response messages from real sources is relatively high, a time difference between DNS response messages having a same domain name is very short in this situation. Therefore, the present disclosure sets up a predetermined time difference, e.g., one second. The predetermined time difference is a time difference that needs to have between two consecutive DNS response messages that have a same domain name and are sent by a normal external network device.

In an event that the historical domain name record includes the target domain name, predetermined conditions for determining the target DNS response message further include a time difference between a first sending time and a second sending time initiated by the external network device for the target domain name being less than a predetermined time difference.

When receiving the target DNS response message, the elimination device uses the current time as a sending time of the target DNS response message, i.e., the first sending time. The most recent sending time of a DNS response message that includes the target domain name and is recorded in the historical domain name record of the elimination device is the second sending time.

If a time difference between the first sending time and the second sending time is less than the predetermined time difference, this indicates that the external network device sends DNS response messages having the same domain name frequently. In other words, a frequency of sending DNS response messages having the same domain name by the external network device is exceedingly high. In this case, it is possible that the external network device attacks the internal network device through a manner of attack that frequently sends DNS response messages having a limited number of domain names or the same domain name. Therefore, the elimination device discards the target DNS response message to protect the internal network device from attacks.

S308 discards the target DNS response message.

S310 transmits the target DNS response message to the internal network device.

If the time difference between the first sending time and the second sending time is less than the predetermined time difference, this indicates that the target DNS response message is a DNS response message sent by a normal external network device for the moment. Therefore the DNS response message is transmitted to the internal network device.

IP addresses in the dynamic white list used by the embodiments of FIGS. 2 and 3 represent devices that are not invasive for the time being only. Therefore, an examination about whether an IP address in the dynamic white list has changed into an invasive device is needed on a regular basis to update the dynamic white list. Specifically, the following approach may be used.

A third way of initiating DNS response attacks from a real source in the dynamic white list can be sending DNS response messages having a relatively large number of domain names that are changing periodically, with a time difference between messages that attack a same domain name being greater than one second. In this case, the above two predetermined conditions cannot eliminate this type of invasive DNS response messages. Therefore, the following method is used for solving the third way of attacks.

Based on the embodiments as shown in FIGS. 2 and 3, the embodiments provided in the present disclosure further include: for DNS response messages sent by the external network device, the elimination device searching the historical domain name record for a domain name in a DNS response message after receiving the DNS response message; and increasing a hit rate of the domain name by one if the domain name in the DNS response message is found in the historical domain name record (which indicates that the domain name is hit), wherein an initial value of a hit rate of each domain name is zero. Therefore, all domain names sent by external network devices, and a respective total hit rate of each domain name are recorded in the historical domain name record.

The present disclosure sets up a predetermined hit rate, and this hit rate is at least three. It is because normal DNS response messages at most send two DNS response message having a same domain name under normal circumstances. After a hit rate of DNS response messages corresponding to a domain name exceeds the predetermined hit rate, this indicates that this domain name is frequently used for sending DNS response messages to the internal network device. Therefore, this domain name can be viewed as an attacked domain name for attacking the internal network device.

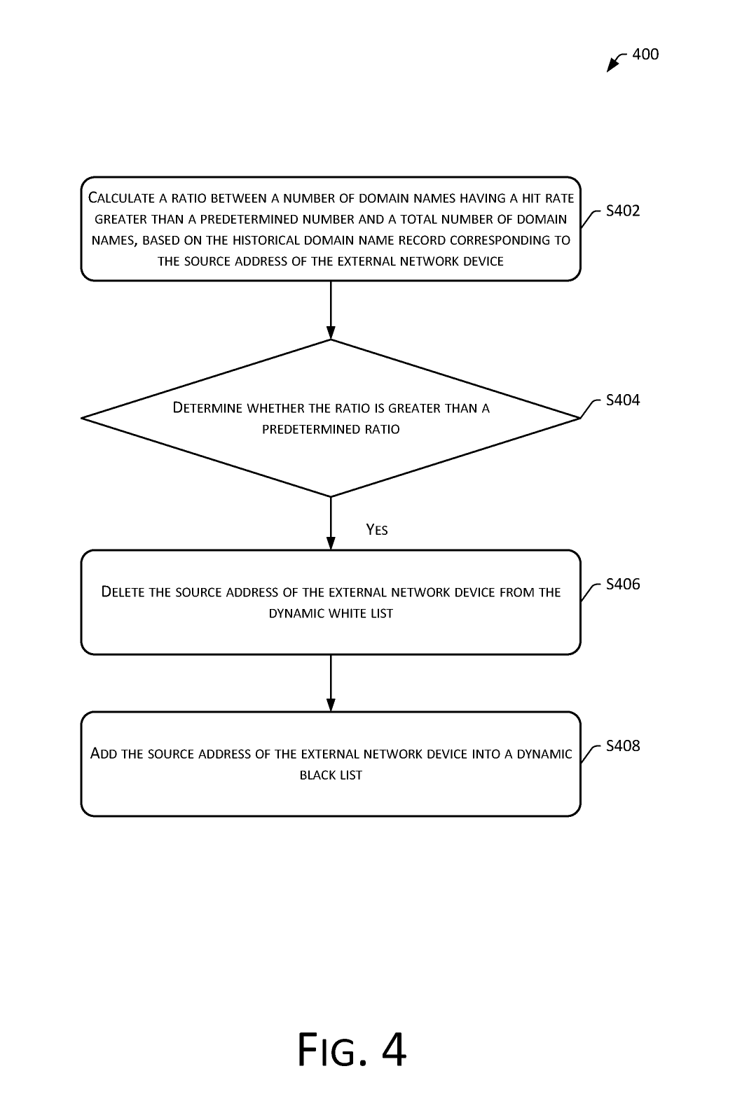

Based on the embodiments shown in FIGS. 2 and 3, the elimination device performs the following operations 400 on a regular basis as shown in FIG. 4.

S402 calculates a ratio between a number of domain names having a hit rate greater than a predetermined number and a total number of domain names, based on the historical domain name record corresponding to the source address of the external network device, wherein the historical domain name record includes all domain names and a respective hit rate associated with each domain name in historical DNS response messages that are sent by the external network device.

A number (a first number) of domain names having a hit rate greater than a predetermined number is counted from the historical domain name record. A goal for doing this is to count a number of attacked domain names sent by the external network device. A total number (a second number) of domain names sent by the external network device is also counted. A ratio between the first number and the second number is calculated to determine a ratio between the attacked domain names and all the domain names sent by the external network device.

S404 determines whether the ratio is greater than a predetermined ratio, proceeds to S406 if affirmative, or performs other processing if not.

The present disclosure can configure a predetermined ratio, such as 0.5, which is used for representing a proportion of attacked domain names among all domain names under normal circumstances.

S406 deletes the source address of the external network device from the dynamic white list.

When the calculated ratio is greater than the predetermined ratio at S402, this indicates that the external network device frequently sends DNS response messages that include attacked domain name(s). In other words, the external network device has changed into an invasive external network device. Therefore, the source address of the external network device is deleted from the dynamic white list.

S408 adds the source address of the external network device into a dynamic black list.

Source addresses of invasive external network devices in the dynamic white list are added into a dynamic black list, so that a DNS response message sent by the external network device is discarded when the external network device sends the DNS response message again, thus protecting the internal network device from being attacked.

The embodiment as shown in FIG. 4 uses a target domain name in a target DNS response message as a starting point, to determine whether the target DNS response message sent by an external network device is invasive, thereby achieving a goal of updating a dynamic white list. Other than a method of using domain names, the present disclosure also provide a method of using throughput to update the dynamic white list.

Specifically, A DNS response message is sent from a source address of an external network device, and the source address is included in a dynamic white list. A throughput value of the DNS response message is added into a throughput value of historical DNS response message. An initial value of the throughput value of the historical DNS response messages is zero. A goal for doing this is to continuously compute a throughput value of DNS response messages that are sent by the external network device.

In this case, the predetermined conditions further include a total throughput value of a throughput value of the target DNS response message and a throughput value of historical DNS response message being greater than a predetermined throughput value, wherein the historical DNS response messages are all DNS response messages sent by the external network device before the target DNS response message is sent.

The present disclosure sets up a predetermined throughput value, which is used for representing a total throughput value sent by the external network device within a time period. A throughput value of DNS response messages that are sent by the external network device within a time period being greater than a predetermined throughput value means that the external network device frequently sends DNS response message. In this case, this represents that the external network device in the dynamic white list has changed into an invasive external network device. Therefore, when the total throughput value is greater than the predetermined throughput value, the source address is deleted from the dynamic white list, and the source address is added into the dynamic black list.

With respect to the third approach of initiating DNS response messages from a real source (sending DNS response messages having many domain names that change periodically and a time difference between messages attacking a same domain name being greater than one second), even though the embodiments as shown in FIGS. 2 and 3 cannot eliminate thereof in time, a determination about whether an external network device is an invasive external network device can be made by regularly examining a total throughput value sent by the external network device or by using a hit rate associated with a domain name that is attacked being greater than a predetermined ratio. If the device is invasive, a source address of the external network device is added into a dynamic black list, so that a DNS response message can be discarded immediately when the external network device sends the message again.

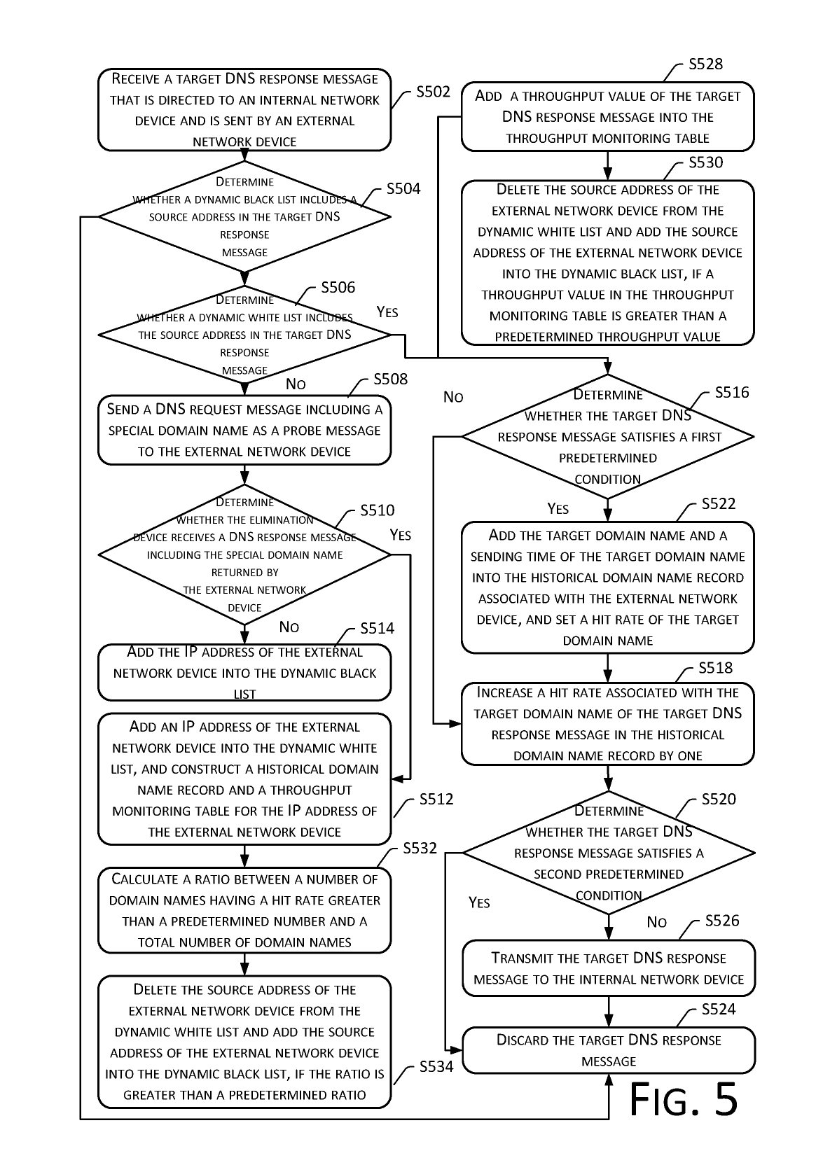

A third embodiment of a prevention method 500 of network attacks provided by the present disclosure is described hereinafter. As shown in FIG. 5, the method 500 includes operations S502-S534.

S502 receives a target DNS response message that is directed to an internal network device and is sent by an external network device.

S504 determines whether a dynamic black list includes a source address in the target DNS response message, proceeds to S524 if affirmative, or proceeds to S506 if not.

After receiving a DNS response message sent from an external network device, an elimination device queries about whether an internal network device corresponding to a destination address is in a defensive status based on the destination address (IP address) of the message. If the internal network device is in a defensive status, the process of the present embodiment can be performed.

A dynamic black list stores source addresses of invasive external network devices. When the source address of the external network device is found in the dynamic black list, the target DNS response message is determined to be an invasive message. In this case, the target DNS response message is discarded.

S506 determines whether a dynamic white list includes the source address in the target DNS response message, proceeds to S516 and S528 if affirmative, or proceeds to S508 if not.

S508 sends a DNS request message including a special domain name as a probe message to the external network device.

The elimination device constructs a DNS request message as a probe message for sending to the external network device. A domain name in the DNS request message can be constructed from quintuple information and domain name information in the target DNS response message through a hash method, and the constructed domain name is ensured to be a domain name that does not exist in a current network.

S510 determines whether the elimination device receives a DNS response message including the special domain name returned by the external network device, proceeds to S512 if affirmative, or proceeds to S514 if not.

After receiving a DNS response message that is sent by the external network device again, the elimination device examines whether a domain name in the message is the one that is constructed at S508. A normal external network device will add the domain name into a DNS response message that is generated based on the DNS request message if receiving the DNS request message. Therefore, if a DNS response message that is received again includes the special domain name, this indicates that the external network device is a normal external network device. Otherwise, this indicates that the external network device is an invasive external network device.

S512 adds an IP address of the external network device into the dynamic white list, and constructs a historical domain name record and a throughput monitoring table for the IP address of the external network device.

S514 adds the IP address of the external network device into the dynamic black list.

S516 determines whether the target DNS response message satisfies a first predetermined condition, the first predetermined condition being a target domain name in the target DNS response message being not included in a historical domain name record, proceeds to S518 if the first predetermined condition is not satisfied, or proceeds to S522 if the first predetermined condition is satisfied.

S518 increases a hit rate associated with the target domain name of the target DNS response message in the historical domain name record by one.

S520 determines whether the target DNS response message satisfies a second predetermined condition, the second predetermined condition being a time difference between a first sending time and a second sending time for accessing the target domain name initiated by the external network device being less than a predetermined time difference, proceeds to S524 if the second predetermined condition is not satisfied, or proceeds to S526 if the second predetermined condition is satisfied.

S522 adds the target domain name and a sending time of the target domain name into the historical domain name record associated with the external network device, and sets a hit rate of the target domain name as one.

S524 discards the target DNS response message.

S526 transmits the target DNS response message to the internal network device.

S528 adds a throughput value of the target DNS response message into the throughput monitoring table.

S530 deletes the source address of the external network device from the dynamic white list and adds the source address of the external network device into the dynamic black list, if a throughput value in the throughput monitoring table is greater than a predetermined throughput value.

S532 calculates a ratio between a number of domain names having a hit rate greater than a predetermined number and a total number of domain names.

S534 deletes the source address of the external network device from the dynamic white list and adds the source address of the external network device into the dynamic black list, if the ratio is greater than a predetermined ratio.

Using the embodiment as shown in FIG. 5, all types of DNS response attacks can be filtered.

The method using the dynamic white list at S506 can filter DNS response attacks from a fake source. The operation of S516 (domain name first packet discarding mechanism) can filter the first approach of DNS response attacks from a real source (randomly changing domain names in attacking messages). The determination at the operation of S520 can filter the second approach of DNS response attacks from a real source (a limited number of domain names or an unchanged domain name in attacking messages). The operations of S530-S534 can filter the third approach of DNS response attacks from a real source (many periodically changing domain names in attacking messages and a time difference between messages attacking a same domain name being greater than one second).

Accordingly, the present disclosure can filter all types of DNS response attacks, and thereby alleviate the impact on services and networks caused by the DNS response attacks.

Corresponding to the prevention method of network attacks provided in the present disclosure, the present disclosure also provides a prevention apparatus 600 of network attacks. In implementations, the apparatus 600 may include one or more computing devices, or may be a part of one or more computing devices. In implementations, the apparatus 600 may be located in a single place, or may be distributed among a plurality of network devices, such as a cloud computing architecture. By way of example and not limitation, the apparatus 600 may include one or more processors 602, an input/output (I/O) interface 604, a network interface 606, and memory 608.

The memory 608 may include a form of computer readable media such as a volatile memory, a random access memory (RAM) and/or a non-volatile memory, for example, a read-only memory (ROM) or a flash RAM. The memory 608 is an example of a computer readable media.

The computer readable media may include a volatile or non-volatile type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In implementations, the memory 608 may include program units 610 and program data 612. The program units 610 may include a receiving unit 614 used for receiving a target DNS response message that is directed to an internal network device and sent from an external network device; a determination unit 616 used for determining whether the target DNS response message satisfies predetermined conditions under a circumstance that a dynamic white list includes a source address in the target DNS response message; and a first discarding unit 618 used for discarding the target DNS response message if the target DNS response message satisfies the predetermined conditions, wherein the predetermined conditions include at least a target domain in the target DNS response message being not included in a historical domain record, each historical domain name in the historical domain name record being extracted from historical DNS response messages sent by the external network device.

The predetermined condition further include a time difference between a first sending time and a second sending time initiated by the external network device for the target domain name is less than a predetermined time difference, wherein the first sending time is a time of sending the target DNS response message, and the second sending time is a time of sending a most recent DNS response message that includes the target domain name prior to the first sending time.

The predetermined conditions further include a total throughput value of a throughput value of the target DNS response message and a throughput value of historical DNS response messages being greater than a predetermined throughput value, wherein the historical DNS response messages are all DNS response messages sent by the external network device before the target DNS response message is sent.

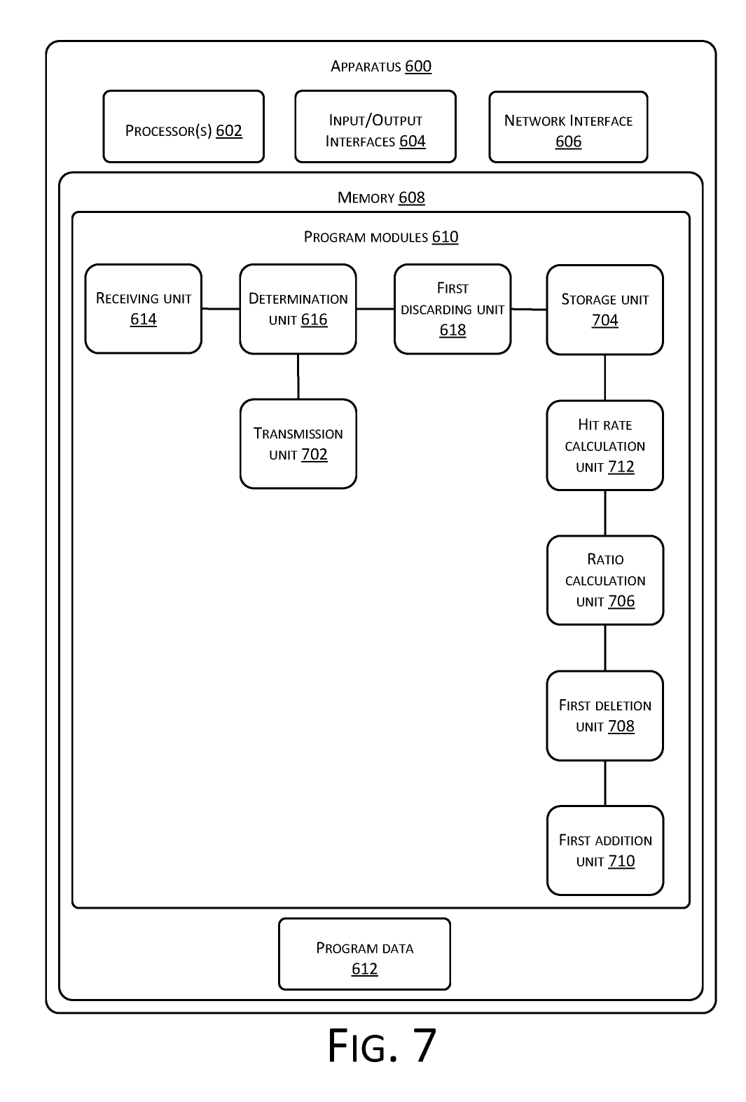

As shown in FIG. 7, the present disclosure provides the prevention apparatus 600 of network attacks in further detail. In implementations, the apparatus 600 may further include a transmission unit 702 used for transmitting the target DNS response message to the internal network device when the time difference is not less than the predetermined time difference; a storage unit 704 used for storing the domain name and a sending time of the target DNS response message into the historical domain name record if the target domain name in the target DNS response message is not included in the historical domain name record; a ratio calculation unit 706 used for calculating a ratio between a number of domain names having a hit rate greater than a predetermined number and a total number of domain names, wherein the historical domain name record includes all domain names and respective hit rates of the domain names in historical DNS response messages sent by the external network device; a first deletion unit 708 used for deleting a source address of the external network device from the dynamic white list if the ratio is greater than a predetermined ratio; and an first addition unit 710 used for adding the source address of the external network device into a dynamic black list; and a hit rate calculation unit 712 used for finding a domain name in a DNS response message in the historical domain name record after receiving the DNS response message, and increasing a hit rate of the domain name by one, wherein an initial value of the hit rate of each domain name is zero.

As can be seen from the above content, the present disclosure has the following beneficial effects.

After determining that a source address in a target DNS response message is included in a dynamic white list, the embodiments of the present disclosure can determine whether an external network device that initiates the target DNS response message is not a fake source, but a real source. A type of initiating DNS response attacks from a real source is to frequently send DNS response messages including different domain names to attack an internal network device. Therefore, the present disclosure sets up a historical domain name record, in which all domain names sent by the external network device are recorded.

When a target domain name in the target DNS response message is not included in the historical domain name record, this indicates that the external network device sends the DNS response message having the target domain name for the first time. In this case, the target DNS response message may be a DNS response attack initiated by the external network device using an approach of different domain names. In order to prevent the internal network device from attacks, the target DNS response message is discarded.

Since normal external network devices have an automatic resending mechanism, if a DNS response message sent by a normal external network device is discarded, the normal external network device will resend a new target DNS response message, and thus sending of normal DNS response messages to an internal network device is not affected. However, an invasive external network device does not have this resending mechanism. Therefore, the present disclosure can filter out DNS response messages that attack an internal device from a real source using an approach of different domain names, thus alleviating the impact on services and networks caused by DNS response attacks.

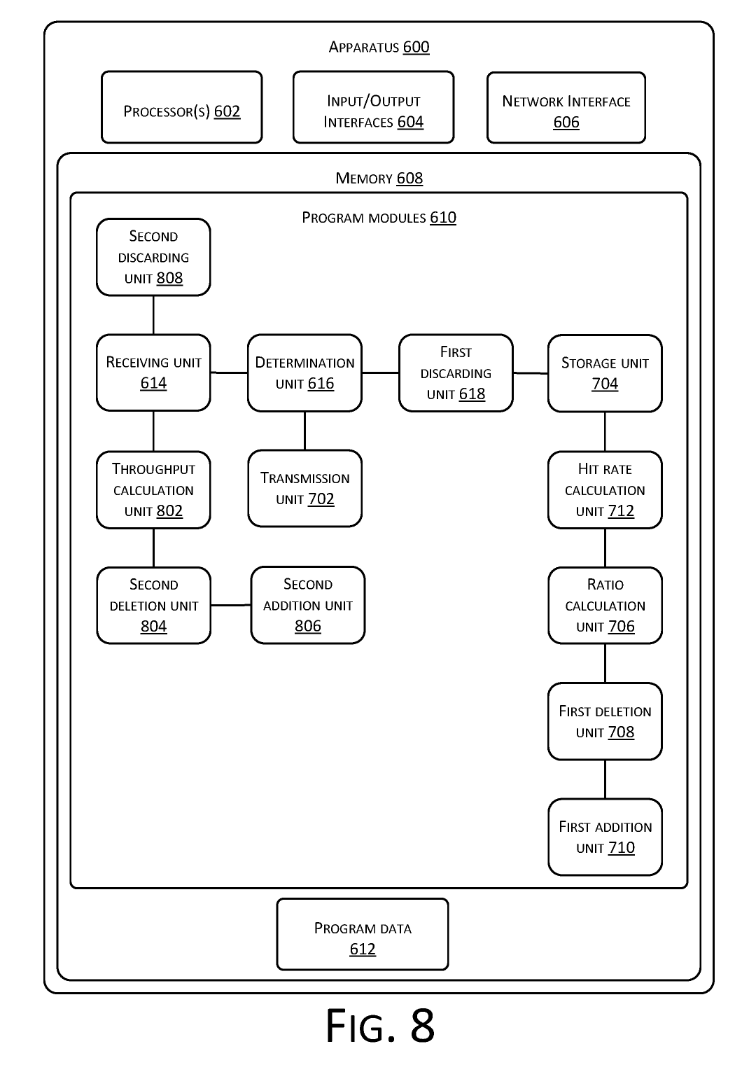

As shown in FIG. 8, the present disclosure also provides the prevention apparatus 600 of network attacks in further detail. In implementations, the apparatus 600 may further include a throughput calculation unit 802 used for adding a throughput value of a DNS response message to the throughput value of the historical DNS response messages after the DNS response message is sent from the source address of the external network device, an initial value of the throughput value of the historical DNS response messages is zero; a second deletion unit 804 used for deleting the source address from the dynamic white list when the total throughput value is greater than the predetermined throughput value; and a second addition unit 806 used for adding the source address into a dynamic black list; and a second discarding unit 808 used for discarding the target DNS response message when the dynamic black list includes the source address in the target DNS response message.

Referring to FIG. 1, the present disclosure provides a prevention system 100 of network attacks, which includes an external network device 102, a routing device 104, an elimination device 108, and an internal network device 106.

The external network device 102 is used for sending a target DNS response message that is directed to the internal network device 106 to the elimination device 108.

The elimination device 108 is used for receiving the target DNS response message that is directed to the internal network device from the external network device; determining whether the target DNS response message satisfies predetermined conditions when a dynamic white list includes a source address in the target DNS response message; and discarding the target DNS response message if the target DNS response message satisfies the predetermined conditions, wherein the predetermined conditions include at least a target domain in the target DNS response message being not included in a historical domain record, each historical domain name in the historical domain name record being extracted from historical DNS response messages sent by the external network device.

The internal network device 106 is used for receiving DNS response message(s) from the elimination device after elimination.

The present system has the following beneficial effects.

After determining that a source address in a target DNS response message is included in a dynamic white list, the embodiments of the present disclosure can determine whether an external network device that initiates the target DNS response message is not a fake source, but a real source. A type of initiating DNS response attacks from a real source is to frequently send DNS response messages including different domain names to attack an internal network device. Therefore, the present disclosure sets up a historical domain name record, in which all domain names sent by the external network device are recorded.

When a target domain name in the target DNS response message is not included in the historical domain name record, this indicates that the external network device sends the DNS response message having the target domain name for the first time. In this case, the target DNS response message may be a DNS response attack initiated by the external network device using an approach of different domain names. In order to prevent the internal network device from attacks, the target DNS response message is discarded.

Since normal external network devices have an automatic resending mechanism, if a DNS response message sent by a normal external network device is discarded, the normal external network device will resend a new target DNS response message, and thus sending of normal DNS response messages to an internal network device is not affected. However, an invasive external network device does not have this resending mechanism. Therefore, the present disclosure can filter out DNS response messages that attack an internal device from a real source using an approach of different domain names, thus alleviating the impact on services and networks caused by DNS response attacks.

Functions described in the method embodiments can be stored in a storage media that is readable by a computing device if being implemented in a form of software functional unit(s) and used or sold as an independent product. Based on this understanding, the parts of the embodiments of the present disclosure that make contribution to the existing technologies or the portions of the technical solutions can be implemented in a form of a software product. The software product is stored in a storage media, which includes instructions that cause a computing device (which may be a personal computer, a server, a mobile computing device, or a network device, etc.) to execute all or some of the method described in each embodiment of the present disclosure. The storage media includes various types of media that is capable of storing program modes, such as a U disk, a movable hard drive, a read-only memory (ROM), a random access memory (RAM), a magnetic disk, or an optical disk, etc.

The embodiments of the present disclosure are described in a progressive manner. Differences between emphases of the embodiments can be referenced to the same or similar portions of the embodiments.

The above description of the disclosed embodiments enables one skilled in the art to implement and use the present disclosure. A number of different modifications to these embodiments are apparent to the one skilled in the art. General principles defined in the present specification can be implemented in other embodiments without departing the spirit and scope of the present disclosure. Therefore, the present disclosure is not limited to these embodiments described in the present specification, but rather is fulfilled in the broadest scope that is consistent with the principles and novel features disclosed in the present specification.

What is claimed is:

1. A method comprising:
receiving a target DNS response message that is directed to an internal network device and sent from an external network device;
determining whether the target DNS response message satisfies predetermined conditions under a circumstance that a dynamic white list includes a source address in the target DNS response message; and
discarding the target DNS response message if the target DNS response message satisfies the predetermined conditions, wherein the predetermined conditions include at least a target domain in the target DNS response message being not included in a historical domain record.

2. The method of claim 1, wherein the predetermined conditions further comprise a time difference between a first sending time and a second sending time initiated by the external network device for the target domain name is less than a predetermined time difference, wherein the first sending time is a time of sending the target DNS response message, and the second sending time is a time of sending a most recent DNS response message that includes the target domain name prior to the first sending time.

3. The method of claim 2, further comprising transmitting the target DNS response message to the internal network device under a circumstance that the time difference is not less than the predetermined time difference.

4. The method of claim 1, further comprising storing the domain name and a sending time of the target DNS response message into the historical domain name record if the target domain name in the target DNS response message is not included in the historical domain name record.

5. The method of claim 4, further comprising:
calculating a ratio between a number of domain names having a hit rate greater than a predetermined number and a total number of domain names, wherein the historical domain name record includes all domain names and respective hit rates of the domain names in historical DNS response messages sent by the external network device, and the predetermined number is not less than a natural number of three;
deleting a source address of the external network device from the dynamic white list if the ratio is greater than a predetermined ratio; and
adding the source address of the external network device into a dynamic black list.

6. The method of claim 5, wherein calculating a hit rate of each domain name in the historical domain name record comprises finding a domain name in a DNS response message in the historical domain name record after receiving the DNS response message; and increasing a hit rate of the domain name by one, wherein an initial value of the hit rate of each domain name is zero.

7. The method of claim 1, wherein the predetermined conditions further comprise a total throughput value of a throughput value of the target DNS response message and a throughput value of the historical DNS response messages being greater than a predetermined throughput value, wherein the historical DNS response messages are all DNS response messages sent by the external network device before the target DNS response message is sent.

8. The method of claim 7, further comprising:
deleting the source address from the dynamic white list in response to the total throughput value is greater than the predetermined throughput value; and
adding the source address into a dynamic black list.

9. The method of claim 8, wherein calculating the throughput value of the historical DNS response messages comprises adding a throughput value of a DNS response message to the throughput value of the historical DNS response messages after the DNS response message is sent from the source address of the external network device, an initial value of the throughput value of the historical DNS response messages is zero.

10. The method of claim 1, further comprising discarding the target DNS response message when the dynamic black list includes the source address in the target DNS response message.

11. An apparatus comprising:
one or more processors;
memory;
a receiving unit stored in the memory and executable by the one or more processors to receive a target DNS response message that is directed to an internal network device and sent from an external network device; a determination unit used for determining whether the target DNS response message satisfies predetermined conditions under a circumstance that a dynamic white list includes a source address in the target DNS response message; and
a first discarding unit stored in the memory and executable by the one or more processors to discard the target DNS response message if the target DNS response message satisfies the predetermined conditions, wherein the predetermined conditions include at least a target domain in the target DNS response message being not included in a historical domain record.

12. The apparatus of claim 11, wherein the predetermined condition further comprise a time difference between a first sending time and a second sending time initiated by the external network device for the target domain name is less than a predetermined time difference, wherein the first sending time is a time of sending the target DNS response message, and the second sending time is a time of sending a most recent DNS response message that includes the target domain name prior to the first sending time, and wherein the apparatus further comprises a transmission unit used for transmitting the target DNS response message to the internal network device when the time difference is not less than the predetermined time difference.

13. The apparatus of claim 11, further comprising a storage unit used for storing the domain name and a sending time of the target DNS response message into the historical domain name record if the target domain name in the target DNS response message is not included in the historical domain name record.

14. The apparatus of claim 11, further comprising:
a ratio calculation unit used for calculating a ratio between a number of domain names having a hit rate greater than a predetermined number and a total number of domain names, wherein the historical domain name record includes all domain names and respective hit rates of the domain names in historical DNS response messages sent by the external network device, and the predetermined number is not less than a natural number of three;
a first deletion unit used for deleting a source address of the external network device from the dynamic white list if the ratio is greater than a predetermined ratio; and
an first addition unit used for adding the source address of the external network device into a dynamic black list.

15. The apparatus of claim 14, further comprising a hit rate calculation unit used for finding a domain name in a DNS response message in the historical domain name record after receiving the DNS response message, and increasing a hit rate of the domain name by one, wherein an initial value of the hit rate of each domain name is zero.

16. The apparatus of claim 11, wherein the predetermined conditions further comprise a total throughput value of a throughput value of the target DNS response message and a throughput value of historical DNS response messages being greater than a predetermined throughput value, wherein the historical DNS response messages are all DNS response messages sent by the external network device before the target DNS response message is sent.

17. The apparatus of claim 16, further comprising:
a second deletion unit used for deleting the source address from the dynamic white list when the total throughput value is greater than the predetermined throughput value; and
a second addition unit used for adding the source address into a dynamic black list.

18. The apparatus of claim 17, further comprising a throughput calculation unit used for adding a throughput value of a DNS response message to the throughput value of the historical DNS response messages after the DNS response message is sent from the source address of the external network device, an initial value of the throughput value of the historical DNS response messages is zero.

19. The apparatus of claim 11, further comprising a second discarding unit used for discarding the target DNS response message when the dynamic black list includes the source address in the target DNS response message.

20. One or more computer-readable media storing executable instructions that, when executed by one or more processors, cause the one or more processors to perform acts comprising:
receiving a target DNS response message that is directed to an internal network device and sent from an external network device;
determining whether the target DNS response message satisfies predetermined conditions under a circumstance that a dynamic white list includes a source address in the target DNS response message; and
discarding the target DNS response message if the target DNS response message satisfies the predetermined conditions, wherein the predetermined conditions include at least a target domain in the target DNS response message being not included in a historical domain record.
